(19) United States
(12) Patent Application Publication
(10) Pub. No.: US 2007/0162357 A1
(43) Pub. Date: Jul. 12, 2007

(54) Cellar management system and methods for managing a wine cellar

(75) Inventors: Shilpa Banerjee, Prospect, KY (US); Philip E. Back, Jeffersonville, IN (US); Scott Hill, Hanover, IN (US); Gregory L. Levinsky, Prospect, KY (US); Rebecca Lynn Woodrow, Mt. Washington, KY (US); Brian Rickabaugh, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/305,950

(22) Filed: Dec. 19, 2005

(51) Int. Cl. G06Q 10/00

(52) U.S. Cl. 705/28

(57) ABSTRACT

An inventory management system is provided for a wine cellar that includes a plurality of walls defining cells for receiving bottles of wine. The system includes a database for storing data relating to the wine cellar and inventory within the wine cellar, a user device for use by a user to access the data stored in the database, and a processor coupled to the database and the user device. The processor is configured to generate an image of each wall of the wine cellar, including individual cells of the wall, when a predetermined parameter of the wine cellar is entered with the user interface device. The processor is also configured to display information stored in the database on the user device regarding the inventory within the cellar.

### BACKGROUND OF THE INVENTION

This invention relates generally to cellar management systems, and more particularly, to a wine cellar management system and method for managing a wine cellar.

The popularity of wine has existed for many years. Today, there exists a variety of wine types, and the variety and complexity is continues to increase. Consumption of wines is often an integral part of meals and for some people, is as important as the meal itself. Likewise, retail sales of wine and a personal collection of wine are becoming more popular throughout the world.

While the consumption and purchase of wine is widespread and popular throughout the world, numerous drawbacks exist in known wine cellar management systems. One such drawback arises as a result of the overwhelming variety of wine available for consumption, both the type of wine and the region from which the wine originates. For a wine connoisseur with a large collection, such as over one thousand bottles, it can be difficult and inefficient to manage the wine collection, i.e., add, remove, search, and analyze, the types of wines in the wine cellar. It is also difficult to manage and maintain the inventory of the wine stored in the wine cellar such that bottles of wine do not go bad from aging too long and bottles are not consumed before they have reached a proper age. In contrast to other consumables, wines are stored in cool, dark locations and are sold and bought by the bottle. As a result, the process of maintaining inventory by physically counting each bottle of available wine is a time consuming and undesirable task. In addition, frequent access to the wine cellar, e.g., to check the status of the wine collection, may adversely affect the conditions of the wine, such as, the temperature and humidity in the wine cellar.

### BRIEF DESCRIPTION OF THE INVENTION

In one aspect, an inventory management system is provided for a wine cellar which includes a plurality of walls defining cells for receiving bottles of wine. The cellar management system includes a database for storing data relating to the wine cellar and inventory within the wine cellar, a user device for use by a user to access the data stored in the database, and a processor coupled to the database and the user device. The processor is configured to generate an image of each wall of the wine cellar, including individual cells of the wall, when a predetermined parameter of the wine cellar is entered via the user device. The processor is also configured to display information stored in the database on the user device regarding the inventory within the cellar.

In another aspect, a cellar management system is provided for managing a wine cellar having a plurality of cell walls. The cellar management system includes a database, a user device, and a processor coupled to the database and the user device. The processor is configured to graphically display an image of at least one wall of the cellar on the user device and enable a user to navigate the image to select a particular bottle of wine.

In still another aspect, a method of managing a cellar which includes a plurality of walls defining cells for receiving bottles of wine is provided. The method utilizes a system including a database, a user device, and a processor coupled to the database and the user device. The method includes displaying an image of at least one wall of the cellar on the user device, and enabling a user to navigate the image to select a particular bottle of wine.

### BRIEF DESCRIPTION OF THE DRAWINGS

FIG. 1 illustrates an exemplary perspective view of a wine cellar in accordance with one embodiment of the present invention;

FIG. 2 is a schematic view of a cellar management system applicable to the wine cellar shown in FIG. 1;

FIG. 3 is a screen shot depicting a left wall of a storage cellar and details regarding a particular selection;

FIG. 4 is a screen shot depicting a left wall of a tasting cellar and details regarding a particular selection;

FIG. 5 is a screen shot of a Detail screen obtained by selecting the Details button for the particular selection shown in FIG. 4;

FIG. 6 is a screen shot depicting a maturity of the cellar depicted in FIG. 4 for the wine bottles currently stored in the wine cellar;

FIG. 7 is a screen shot of a Detail list screen obtained by selecting a quantity cell in the screen shot depicted in FIG. 6;

FIG. 8 is a screen shot depicting a maturity timeline of the cellar depicted in FIG. 4 for the wine bottles currently stored in the wine cellar; and

FIG. 9 is a screen shot of a remove bottle screen that allows a user to remove a bottle from the data stored in the system depicted in FIG. 2.

### DETAILED DESCRIPTION OF THE INVENTION

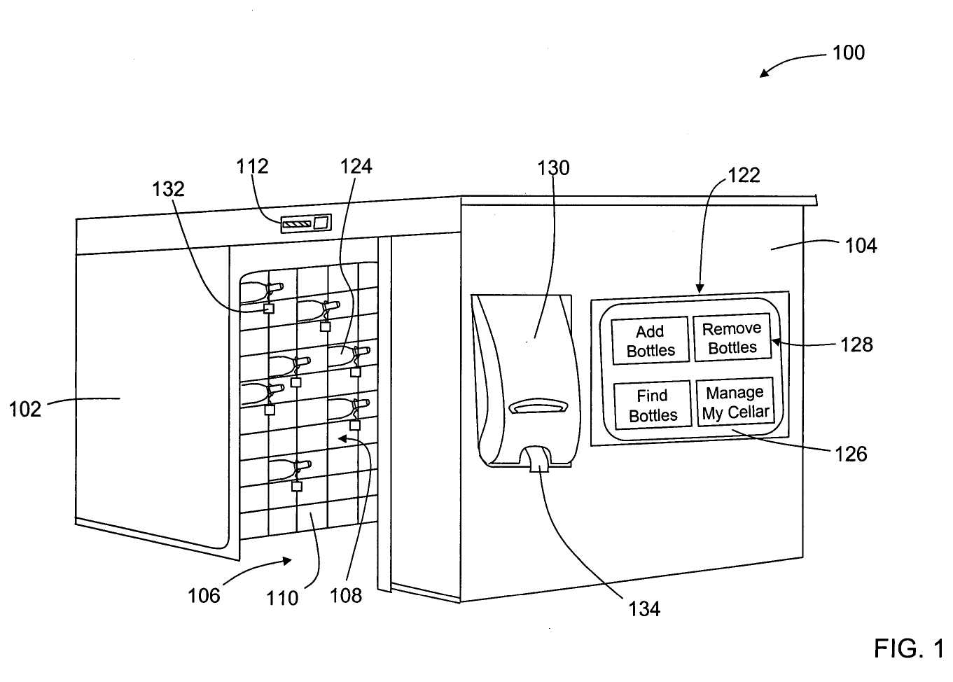

FIG. 1 illustrates an exemplary perspective view of a wine cellar 100 in which the present invention may be practiced. In one exemplary embodiment, wine cellar 100 includes only a storage cellar having of a plurality of wood paneled walls. In another embodiment, wine cellar 100 includes a storage cellar and a tasting cellar equipped with a tasting area. Of course it should be recognized that cellar 100 can be customized to suit the individual tastes of the those that will be using it. In the exemplary embodiment, wine cellar 100 is fabricated from stainless steel and insulating materials, such as high-density foam, to ensure a predetermined temperature and energy-efficient performance. Wine cellar 100 may be located in a recreation room, or in other living spaces, such as a large pantry, library, loft-style kitchen, or a casual dining area. Alternatively, cellar 100 may be located in a basement or other room contained below ground level. It is recognized, however, that the benefits of the present invention are equally applicable to other types of wine cellars and other wine storage containers. Consequently, the description set forth herein is for illustrative purposes only and is not intended to limit the invention in any aspect.

In the exemplary embodiment, wine cellar 100 has a cube shape and includes a front wall 102, a rear wall (not shown), a left sidewall (not shown), and a right sidewall 104. An entrance way 106 is defined through front wall 102 for accessing an interior of cellar 100. A door (not shown) is used to seal the interior of cellar 100 and separate it from the ambient environment such that a controlled environment exists. The interior of cellar 100 includes a plurality of racks 108 mounted to at least one inside wall. In the exemplary embodiment, racks 108 are moisture-resistant redwood racks mounted to every inside wall. A plurality of cells 110 are defined in racks 108 for single bottle, double bottle, and triple bottle storage, while also accommodating magnum bottles and crates. A thermostat 112 is positioned on one of the walls to control temperature, allowing adjustment between 40 and 70 degrees Fahrenheit, while maintaining ideal humidity conditions.

A cellar management system 200 includes a first user input terminal, or user device 202, such as a personal computer, to efficiently manage a large quantity of wine bottles 114 received within respective cells 114 of cellar 100. First user device 202 includes a touch screen 204 having a plurality of main menus 206 displayed thereon as well as drop-down menus (not shown) to assist in the proper management of the inventory of wine cellar 100. Main menus 206 and the drop-down menus allow the user to utilize a pre-loaded database to classify each bottle entered into cellar management system 200 and track it during its stay in cellar 100, as will be described in more detail hereinafter.

A printer 208 is operatively coupled to first user device 202 for printing a bar-code label 210 that contains specific information regarding each wine. Label 210 is then affixed to a reusable plastic tag which is placed on a particular bottle. Each bottle within cellar 100 includes such a tag attached thereto for easy identification in wine cellar 100. A scanner 212 is operatively coupled to first user device 202 and is configured to scan bar-code label 210 and display specific information about each wine bottle on a display terminal of first user device 202. In the exemplary embodiment, scanner 212 is integrally formed with printer 208 and both printer 208 and scanner 212 are positioned adjacent first user device 202. In an alternative embodiment, first user device 202, printer 208, and scanner 212 are integrated into a single unit.

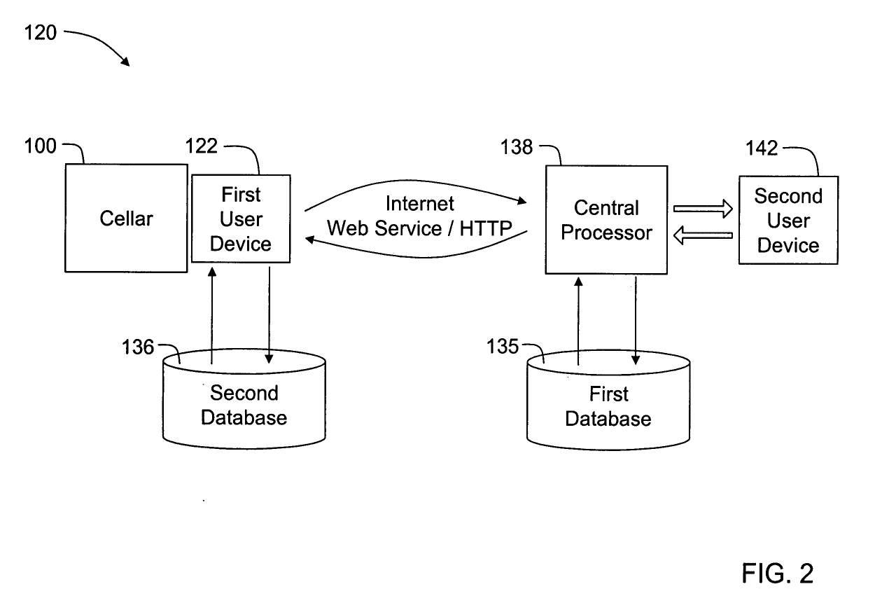

FIG. 2 is a schematic view of cellar management system 200 shown in FIG. 1. Cellar management system 200 includes a database 214 for storing data such as specific information about each wine bottle for all of the inventory within wine cellar 100 through first user device 202. Cellar management system 200 also includes a processor 216, such as a central server, operatively coupled to first user device 202 via a network which is a high-speed internet connection or other similar networks. Processor 216 is also coupled to database 214 and is configured to display information stored in database 214 on the display terminal of first user device 202 regarding the inventory within wine cellar 100. First user device 202, in one embodiment, is a user interface that includes a display portion, such as a screen, and an input portion, such as a keyboard. In another embodiment, the display portion and the input portion are combined and form a touch screen operable by the user.

In the exemplary embodiment, a second user device 218 is, operatively coupled to processor 216 via a high-speed internet connection such that a user can access database 214 from either first user device 202 or second user device 218. Alternatively, processor 216 is operatively coupled to printer 208 and scanner 212, respectively. In the exemplary embodiment, second user device 218 is remote from wine cellar 100 and both first user device 202 and second user device 218 are configured to allow a user to actively manage the wine bottles in wine cellar 100. In the exemplary embodiment, processor 216 is configured to process database 214 based on instructions from either first user device 202 or remotely transmitted from second user device 218.

In use, system 200 allows a user to view an image of wine cellar 100 through either first user device 202 or second user device 218. In addition, system 200 enables the user to add and/or remove a wine bottle from database 214, search for a particular bottle that satisfies a given criteria, and reserve a bottle for immediate use.

In the exemplary embodiment, application software, such as, Macromedia Flash is used to create an image of cellar 100. The user is prompted by system 200 to enter configuration of a wine cellar such as cellar 100. Requested information includes items such as number of walls, bin size, number of rows and number of columns. After the user inputs the requested information, a replica is generated for each wine rack 108 and an image can then be displayed on first user device 202. Once the image is generated, a user can modify the image to more accurately reflect the true configuration of cellar 100.

As explained in more detail below, the user can view every wall in their cellar, and every storage space on the wall. The user can move from one wine cell to another by touching the cell, or by using a navigator on the screen to view more details. The user can easily manage the wine bottles by utilizing such graphic image of each inside wall of the wine cellar. The user can track an age of the wine, compare the age to a known life span for the particular type of wine, and indicate the status of each bottle within cellar management system 200. As such, the user knows the location of wine bottles based on different symbols which indicate specific types of the wine. More specifically, the user can select a “left wall” button to view wine bottles arranged on a left inside wall of wine cellar 100 and select a “right wall” button to view wine bottles arranged on a right inside wall of wine cellar 100.

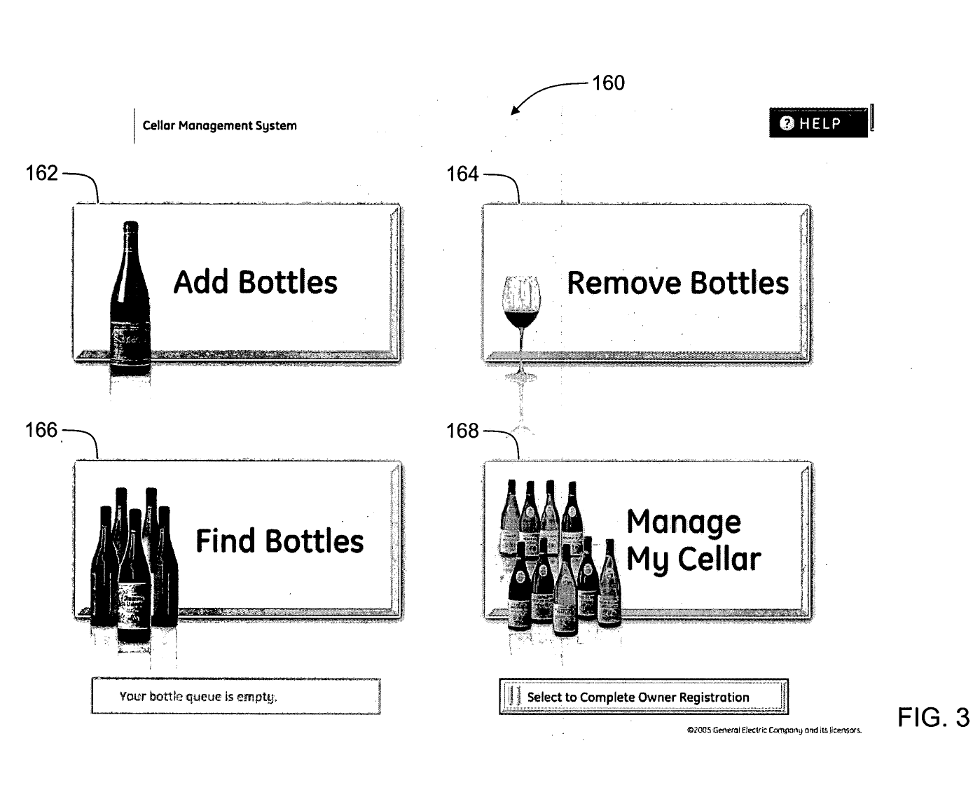

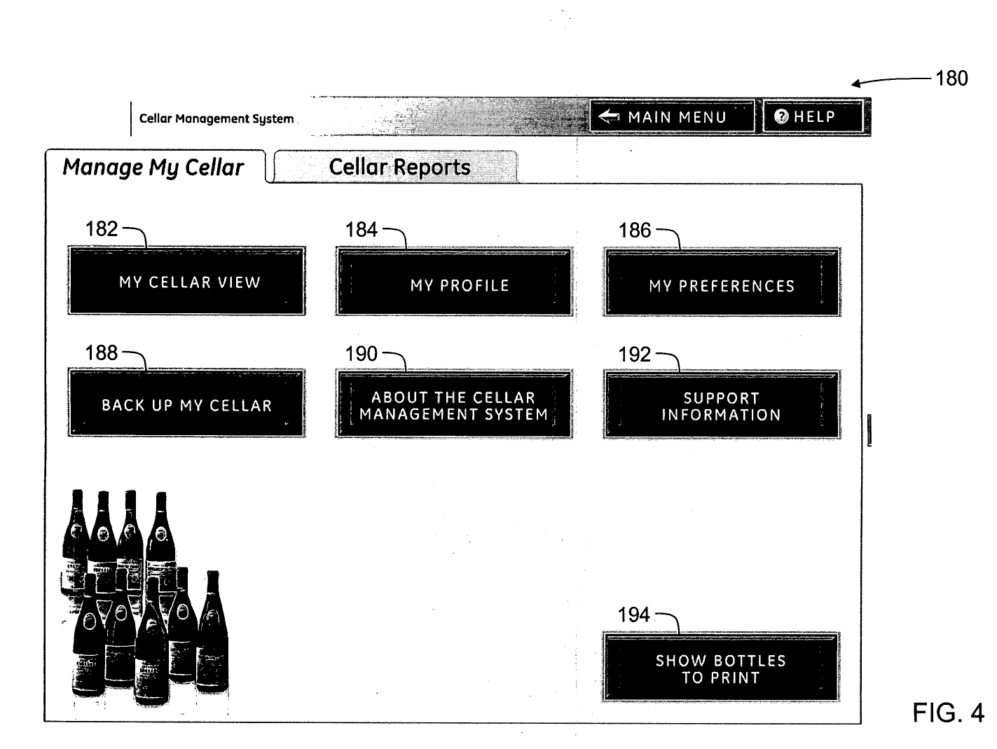

FIG. 3 is a screen shot 220 depicting a left wall 222 of a storage cellar and details regarding a particular selection. FIG. 4 is a screen shot 224 depicting a left wall 226 of a tasting cellar and details regarding a particular selection. As shown in screen shots 220, 224, a left wall of the cellar includes a plurality of cells filled with either a red wine or a white wine. As shown in FIG. 4, a cursor or selector 228 is located on a specific position, overlapping with a symbol of a wine bottle after the user selects a “left wall” button 230. Selection of either a “center wall” button or a “right wall” button will change the view to the appropriate selection. A display portion 232 on the right of screen 224 indicates preliminary data regarding the wine bottle selected with selector 228. Such data includes information such as, position, age, volume, drinkability status, and region and country of origin. For further detailed information, a “Details” button 232 within display portion 230 is provided for the user to obtain additional information regarding the selection as will be described herein below. A navigator 234 is provided under display portion 232 to allow the user to graphically move from one cell to another by selecting the cell using navigator 234.

In the exemplary embodiment, if the user selects “cellar view options” button 236 above display portion 230, the user is able to configure the data to be presented in a particular manner. In addition, a report about the wine in cellar 100 can be run. In one embodiment, such a report is used to generate a graph which enables a user to know the status of the wine bottles in cellar 100. After the report is generated, it can be printed using printer 208.

In addition, system 200 is configured to determine the amount of empty space contained in cellar 100 and the age of the wine compared to the optimum age for drinking each particular bottle. The space determination accounts for cells sized to include multiple bottles of wine. In one embodiment, the empty space is determined utilizing a volume based algorithm.

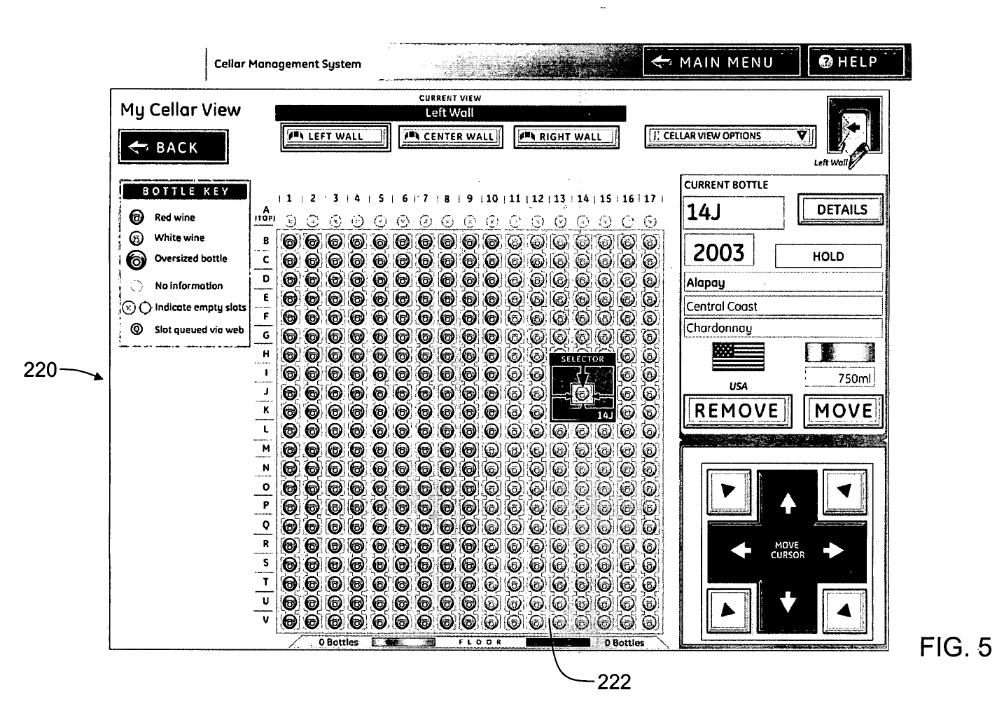

FIG. 5 depicts a screen shot 240 displayed after the “Details” button 232 (shown in FIG. 4) is selected. Detail screen shot 240 includes details regarding the particular wine selected by the user. Such details include one or more of vintage, producer, price, designation, color/type, appellation, and bottle size. In addition, there is an area that may include personal notes and/or expert notes regarding the wine. There is also a rating that a user can attach to the bottle as well as maturity information. In one embodiment, the user inputs the data regarding the maturity, the rating, and the expert notes. In an alternative embodiment, system 200 populates one or more of these fields with the appropriate information. Also, there is included on screen shot 240 a listing of each bottle that meets pre-selected criteria of the selection. In one embodiment, the criteria includes all bottles produced by a particular producer (Silver Lake). Selection of the “Cancel” button 242 returns the user to the previously viewed screen.

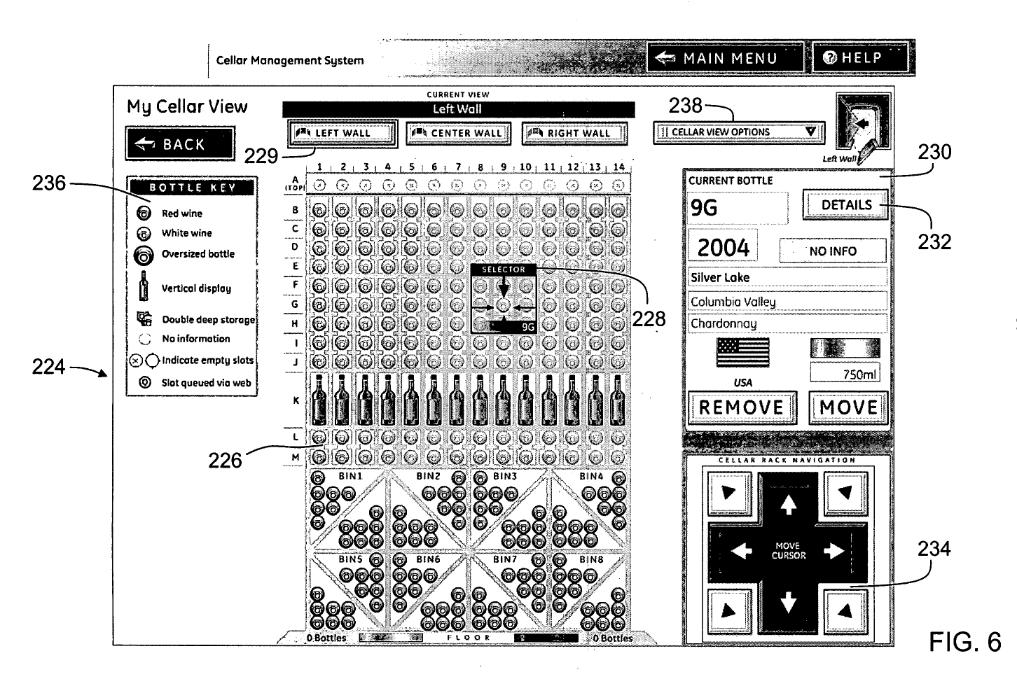

FIG. 6 is a screen shot 250 depicting a maturity of the cellar depicted in FIG. 4 for wine bottles currently stored in cellar 100. A user is able to view screen shot 250 by selecting the “Manage my cellar” button on the initial screen (shown in FIG. 1). Screen shot 250 is utilized to find a particular bottle of wine that is appropriately aged for drinking. Screen shot 250 is also utilized to actively manage the wines within cellar 100. For example, if too many bottles are listed in the drink, in decline, or past peak blocks, then the user can make an informed decision regarding whether to sell the excess bottles or consume the wine from those bottles. Such features guide the user towards drinking bottles of wine at the right maturity level to be consumed. More specifically, when the user selects “cellar maturity” 230, screen shot 250 shows the maturity status of the wine in wine cellar 100 and other specific information regarding the wine.

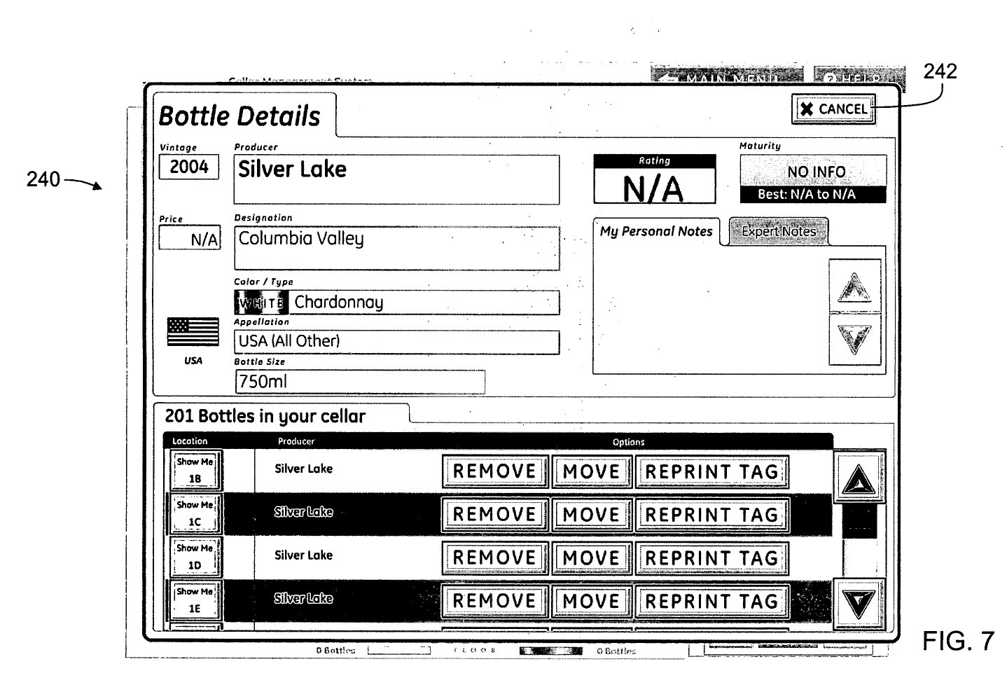

As shown in FIG. 6, screen shot 250 includes a matrix that drills down into categories of wine at a high level. In the exemplary embodiment, a user selects a sorting category 252 and system 200 then builds the matrix according to that selection. For example, the user has selected country and accordingly, one axis of the matrix is country while the other axis is the maturity status. Other categories that can be selected include type of wine, wine region, age of wine, price, rating, and number of bottles. If it is desired to obtain more information regarding the information contained in a particular matrix cell 254, the user simply highlights the cell and then selects the cell. A Detail screen 260, similar to that shown in FIG. 7 is then displayed and a listing of all bottles that satisfy a given criteria are shown.

FIG. 7 depicts additional details regarding the wines contained within the cell previously selected from FIG. 6. The details include information such as vintage, producer, price, country, rating, maturity, and number of bottles. The user moves back to the previous screen by simply selecting a “Back” button 262.

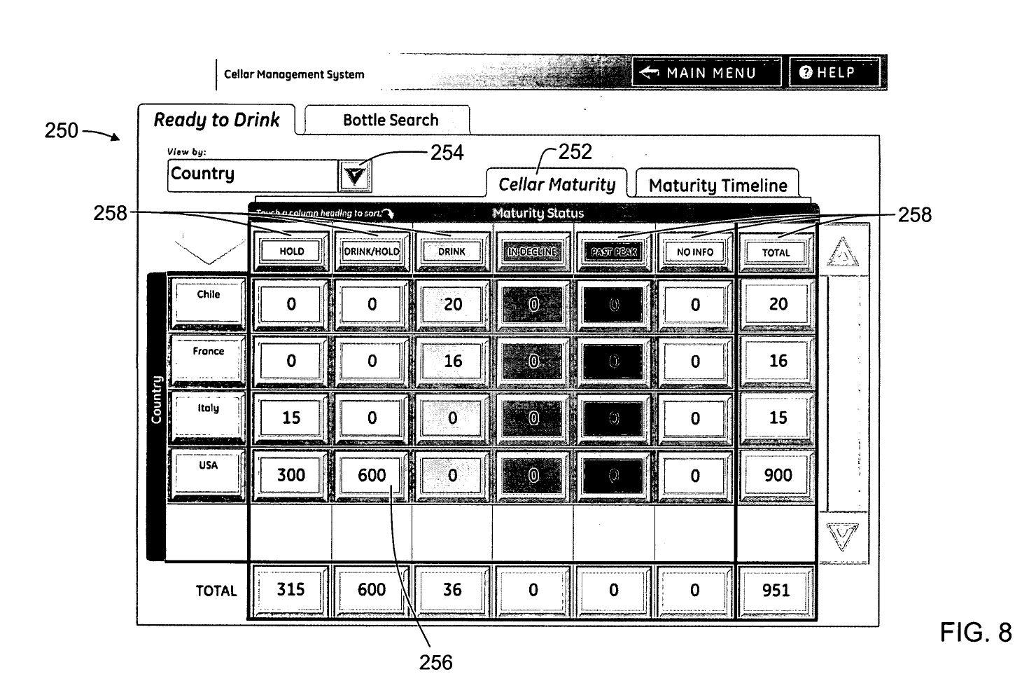

FIG. 8 is a screen shot 270 depicting a maturity timeline of the cellar depicted in FIG. 4 for the wine bottles currently stored in cellar 100. Screen shot 270 includes a listing by year of wines that are ready to be consumed. In the exemplary embodiment, a user selects a sorting category 272 and system 200 then builds the matrix according to that selection. For example, the user has selected country and accordingly, one axis of the matrix is country while the other axis is the best year to drink timeline. Other categories that can be selected include type of wine, wine region, age of wine, price, rating, and number of bottles. If it is desired to obtain more information regarding the information contained in a particular matrix cell 274, the user simply highlights the cell and then selects the cell. A Detail screen 260, such as that shown in FIG. 7 is then displayed.

In the exemplary embodiment, wine bottles are added in at least two ways. One way utilizes a user input terminal, such as a key board (not shown), to input specific information about wine bottles into database 214 (shown in FIG. 2). Such information includes at least some of: the location of wine bottles in wine cellar 100, producer, originating area, country, maturity, wine type, and other information pertinent to storage of the wine. The second way utilizes bar-code tag 210 (shown in FIG. 1) which contains specific information about the wine. Tag 210 is properly positioned with respect to scanner 212 such that scanner 212 can read the data stored on tag 210. The specific information contained on tag 210 is displayed on the user interface of at least one of computers 202, 218. Once such information is verified by the user, specific information about the wine is stored in database 214 by selecting an “OK” button (not shown).

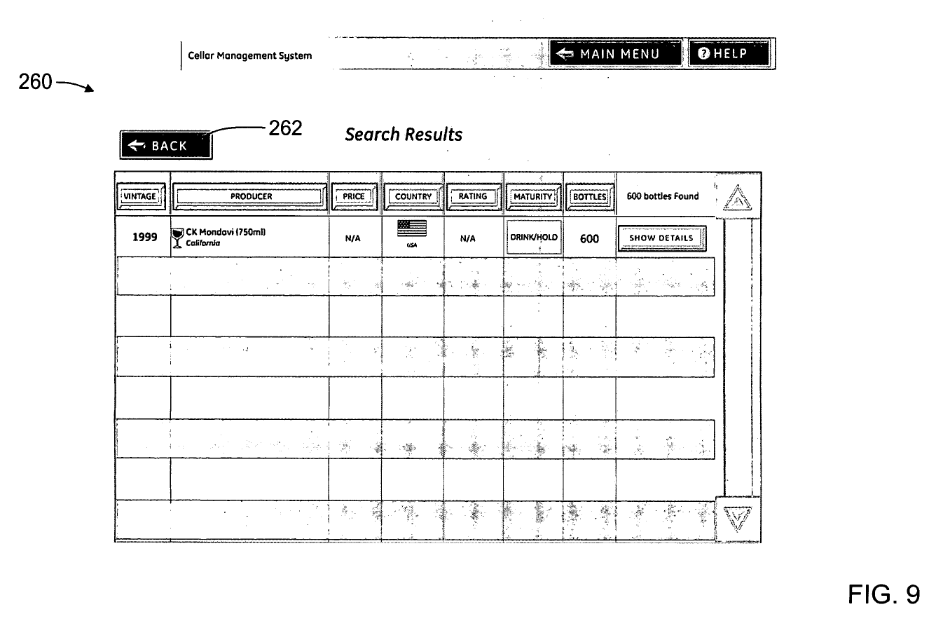

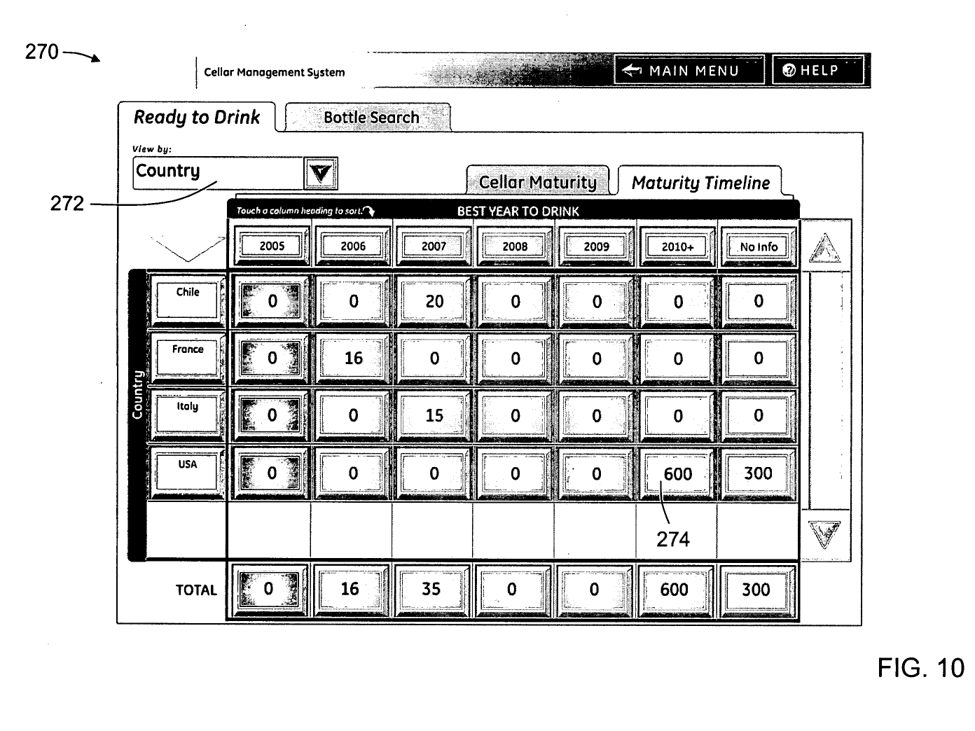

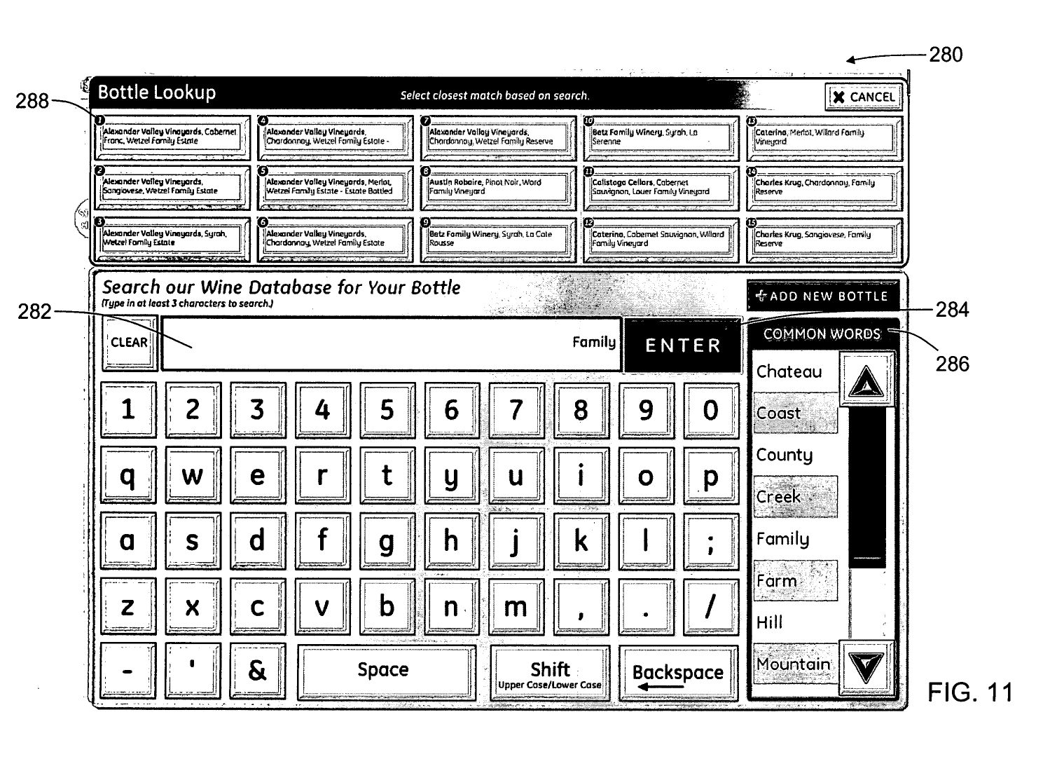

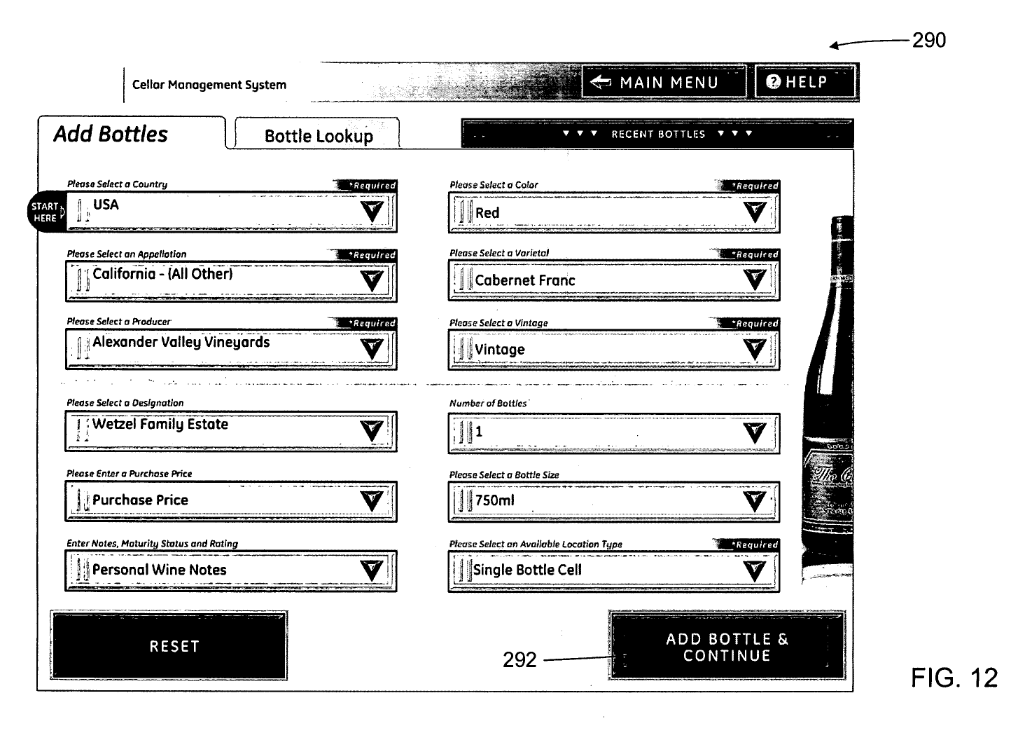

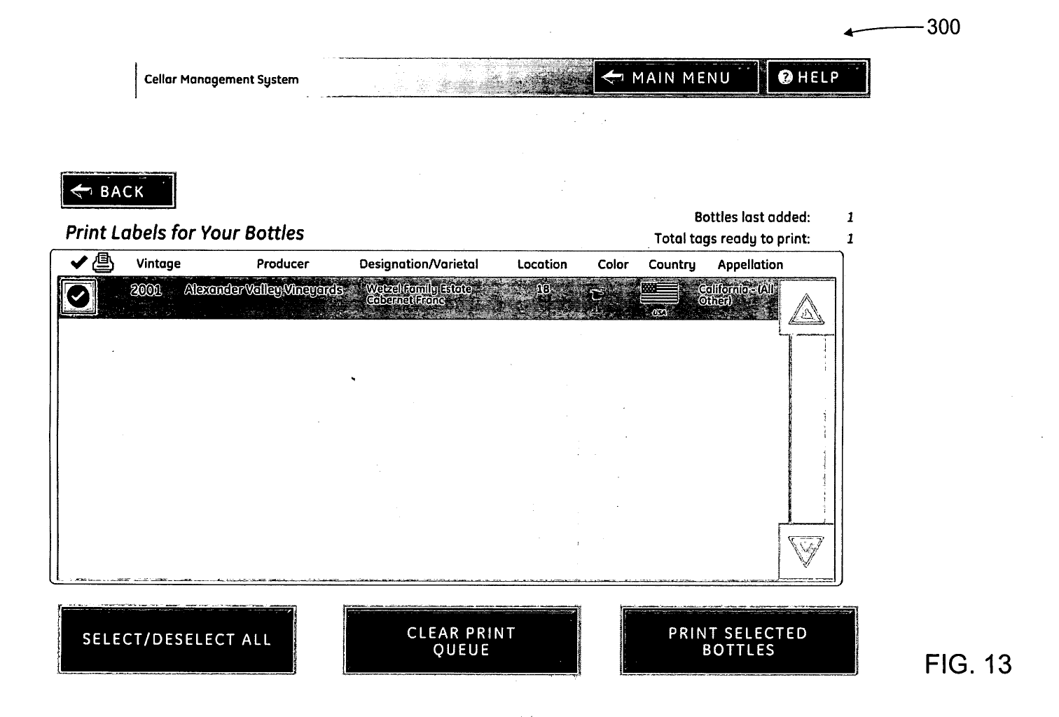

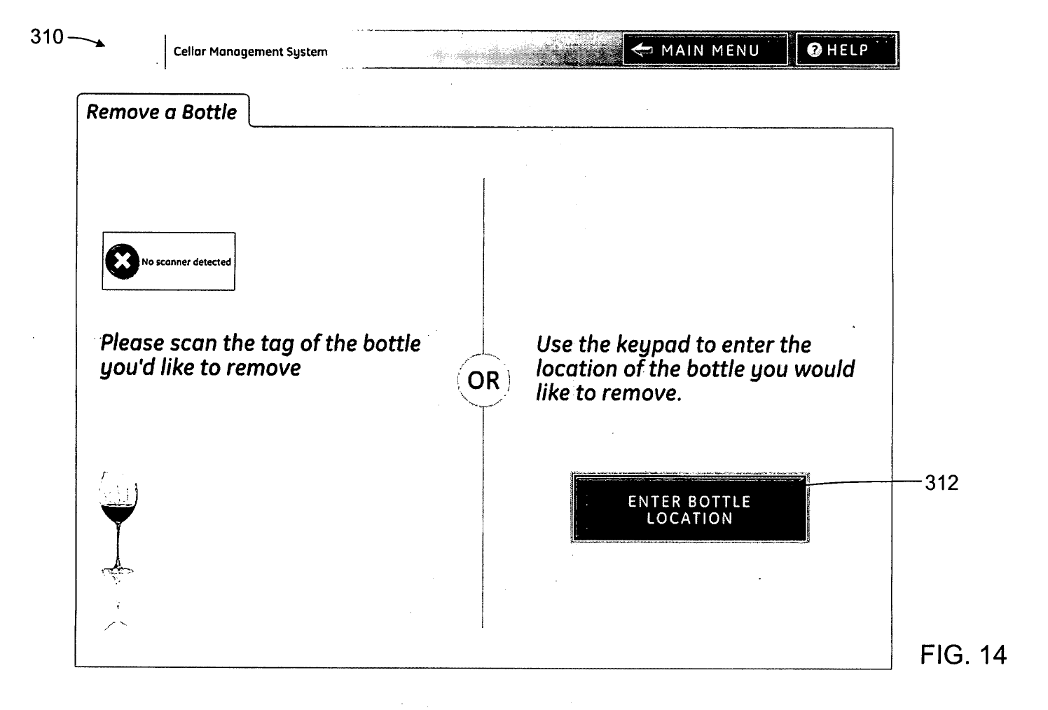

FIG. 9 is a screen shot 280 of a remove bottle screen that allows a user to remove a bottle from the data stored in system 200 (shown in FIG. 2). There are at least two ways to remove a bottle from the inventory of cellar 100 and system 200. One approach utilizes a keypad (not shown) to enter the location of the bottle you would like to remove. An “Enter bottle location” button is selected by the user to access a screen that accepts the information specific to the bottle being removed. Selection of a “remove bottles” option instructs processor 216 (shown in FIG. 2) to delete the desired bottle record from database 214 (shown in FIG. 2). The second approach utilizes bar-code scanner 212 (shown in FIG. 2) to scan bar-coded tag 210 (shown in FIG. 2) of the bottle to be removed. Tag 210 is removed from the neck of the removed bottle and is positioned such the scanner 212 can detect the information contained on tag 210. Once bar-coded tag 210 is scanned by scanner 212, processor 216 deletes the bottle record from database 214.

Searches to find a specific bottle of wine are initiated by selecting the “find bottles” option (see FIG. 1). For example, the user can search for a red wine made in France before Feb. 1980. After the “find bottles” option is selected, a search frame and a search option are displayed on the screen of at least one of computers 202, 218. The user inputs key words, such as, red wine, France, before February 1980, and selects the search button. Processor 216 processes database 214 to identify wine bottles which meet criteria input by the user. This search function also allows the user to add a wine to their own collection.

In the exemplary embodiment, the user can reserve a wine for consumption in wine cellar 100 from a remote location using second user device 218. In the exemplary embodiment, the user can browse the computer generated image of each inside wall of wine cellar 10 to determine which wine to select. Alternatively, a desired bottle can be found and reserved by inputting one or more keywords with a keyboard. Then, the user selects the listed wine icon on the screen of the computers. As such, second user device 218 queues the bottle and indicates the bottle has been reserved for removal. This information is then stored in database 214 so it can be access from any user device.

Additionally, wine cellar 100 can be managed remotely through a web site. The web site also enables the user to back up their database containing the local inventory data. Other remote user devices or similar terminals can be connected to server or processor 216 via a network to access database 214 of system 200. A wireless terminal, such as, a cell phone, a personal digital assistant, or a laptop computer can also be used to access database 214 and thereby manage wine cellar 100 via a wireless network.

The cellar management system described above generate an image of the wine cellar so that the contents of the cellar can be managed by the user. This management can occur either at the cellar or remotely through a network. The system can determine the empty space within the cellar and the status of each bottle of wine with regard to when the bottle is properly aged for drinking. Bottles can be reserved through the user devices and a prompt can be generated by the system to remind the user that a particular bottle has been reserved.

While the invention has been described in terms of various specific embodiments, those skilled in the art will recognize that the invention can be practiced with modification within the spirit and scope of the claims.

We claim:

1. An inventory management system for a wine cellar that includes a plurality of walls defining cells for receiving bottles of wine, said system comprising:
a database for storing data relating to the wine cellar and inventory within the wine cellar;
a user device for use by a user to access the data stored in said database; and
a processor coupled to said database and said user device, said processor configured to:
generate an image of each wall of the wine cellar, including individual cells of the wall, when a predetermined parameter of the wine cellar is entered with said user interface device; and
display information stored in said database on said user device regarding the inventory within the cellar.

2. A system in accordance with claim 1 wherein said processor is configured to run a Macromedia Flash program to generate the image.

3. A system in accordance with claim 1 further comprising a printer operatively coupled to said processor, said printer configured to print information about the bottles.

4. A system in accordance with claim 1 wherein said system further comprises a user system connected with said processor via a high-speed network, said user system configured to access said database and display the stored information regarding the inventory within the cellar.

5. A system in accordance with claim 1 wherein said user device comprises a touch screen that enables a user to manage the bottles on said computer-based device.

6. A system in accordance with claim 1 wherein said processor configured to create a replica of each wine rack in the cellar.

7. A system in accordance with claim 1 wherein said processor further configured to graphically move from one cell to another cell by at least one of selecting the cell and by using a navigator on the screen.

8. A system in accordance with claim 1 wherein said processor configured to locate and display on said user device, a particular cell that includes a specific bottle of wine.

9. A system in accordance with claim 1 wherein said processor configured to utilize a volume based algorithm to determine how much space remains empty on a particular shelf in the cellar.

10. A system in accordance with claim 9 wherein the algorithm accounts for cells that are sized to include multiple bottles of wine.

11. A cellar management system for managing a wine cellar having a plurality of cell walls, said system comprising:
a database;
a user device; and
a processor coupled to said database and said user device, said processor configured to display an image of at least one wall of the cellar on said user device and enable a user to navigate the image to select a particular bottle of wine.

12. A system in accordance with claim 11 wherein said database includes specific features of each wine bottle and parameters of the wine cellar.

13. A system in accordance with claim 11 wherein said processor configured to utilize a volume based algorithm to determine how much space remains empty on a particular shelf of the cellar.

14. A system in accordance with claim 13 wherein the algorithm accounts for cells that are sized to include multiple bottles of wine.

15. A system in accordance with claim 11 wherein said processor is configured to run a Macromedia Flash program to generate the graphic image.

16. A system in accordance with claim 11 further comprising a printer operatively coupled to said processor, said printer configured to print information about the bottles.

17. A system in accordance with claim 11 wherein said system further comprises a user system connected with said processor via a high-speed network, said user system configured to access said database and display the stored information regarding the inventory within the cellar.

18. A system in accordance with claim 11 wherein said user interface device comprises a touch screen that enables a user to manage the bottles on said computer-based device.

19. A system in accordance with claim 11 wherein said processor configured to create a replica of each wine rack within the cellar.

20. A system in accordance with claim 11 wherein said processor further configured to graphically move from one cell to another cell by at least one of selecting the cell and using a navigator on the screen.

21. A system in accordance with claim 11 wherein said processor configured to locate and display on said user interface device, a particular cell that includes a specific bottle of wine.

22. A method of managing a cellar which includes a plurality of walls defining cells for receiving bottles of wine, the method utilizes a system including a database, a user device, and a processor coupled to the database and the user device, said method comprising:
displaying a computer generated image of at least one wall of the cellar on the user device; and
enabling a user to navigate the image to select a particular bottle of wine.

23. A method in accordance with claim 22 wherein the database includes specific features of each wine bottle and parameters of the wine cellar.

24. A method in accordance with claim 22 further comprising utilizing a volume based algorithm to determine how much space remains empty on a particular shelf of the cellar.

25. A method in accordance with claim 22 wherein the algorithm accounts for cells that are sized to include multiple bottles of wine.

26. A method in accordance with claim 22 wherein said method utilizes a Macromedia Flash program to generate the graphic image.

27. A method in accordance with claim 22 wherein the system further includes a user system connected with the processor via a high-speed network, said method comprising accessing the database and displaying the stored information regarding the inventory within the cellar with the user system.

28. A method in accordance with claim 22 further comprising creating a replica of each wine rack within the cellar.

29. A method in accordance with claim 22 further comprising:
graphically moving from one cell to another cell on the user device; and
locating and displaying on the user device, a particular cell that includes a specific bottle of wine.
